(19) United States
(12) Patent Application Publication
(10) Pub. No.: US 2025/0245426 A1
(43) Pub. Date: Jul. 31, 2025

(54) SYSTEMS AND METHODS FOR RELATION LABELLING PIPELINE

(71) Applicant: Walmart Apollo, LLC, Bentonville, AR (US)

(72) Inventors: Jiao Chen, Bellevue, WA (US); Luyi Ma, San Jose, CA (US); Xiaohan Li, Sunnyvale, CA (US); Nikhil Shripad Thakurdesai, Mountain View, CA (US); Jianpeng Xu, Cupertino, CA (US); Hyun Duk Cho, San Francisco, CA (US); Kaushiki Nag, Sunnyvale, CA (US); Evren Korpeoglu, San Jose, CA (US); Sushant Kumar, San Jose, CA (US); Kannan Achan, Saratoga, CA (US)

(21) Appl. No.: 19/030,549

(22) Filed: Jan. 17, 2025

Related U.S. Application Data
(60) Provisional application No. 63/627,222, filed on Jan. 31, 2024.

(51) Int. Cl. G06F 40/186; G06F 16/383; G06Q 30/0601

(52) U.S. Cl. CPC G06F 40/186; G06F 16/383; G06Q 30/0631

(57) ABSTRACT

Systems and methods for generating an interface including recommended elements selected using generated element type relation labels are disclosed. An interface generation request including at least one element type is received and a set of recommended elements is generated based on element type relations between the at least one element type and additional element types associated with a network interface. The element type relations are generated by at least one large language model and at least one optimal relation generation prompt. An interface including the set of recommended elements is generated.

### CROSS-REFERENCE TO RELATED APPLICATION

This application claims benefit under 35 U.S.C. § 119 (e) to U.S. Provisional Appl. Ser. No. 63/627,222, filed Jan. 31, 2024, entitled “Systems and Methods for Relation Labelling Pipeline,” the disclosure of which is incorporated herein by reference in its entirety.

### TECHNICAL FIELD

This application relates generally to relation labelling processes, and more particularly, to relation labelling using large language models (LLMs).

### BACKGROUND

Knowledge graphs provide structured information about entities and relationships between entities. Knowledge graph completion is the process of prediction relations that have not yet been observed between entities within a knowledge graph. Although preliminary attempts have been made to apply knowledge graph completion in the context of large network environments, such initial attempts face numerous challenges, including the dynamic nature of large network domains and an increasing requirement of time and resources.

Some current knowledge graph solutions focus on connections between entities that are identified based on network transactions. Such systems are unable to incorporate or process network transactions including random combinations of entities, resulting in false positive connections. In addition, current systems are not able to model connections for new entities or tail (e.g., long-tail) entities.

### SUMMARY

In various embodiments, a system including a non-transitory memory and a processor communicatively coupled to the non-transitory memory is disclosed. The processor is configured to read a set of instructions to receive an interface generation request including at least one element type and generate a set of recommended elements based on element type relations between the at least one element type and additional element types associated with a network interface. The element type relations are generated by at least one large language model and at least one optimal relation generation prompt. The processor is further configured to generate an interface including the set of recommended elements.

In various embodiments, a computer-implemented method is disclosed. The computer-implemented method includes steps of receiving an interface generation request including at least one element type and generating a set of recommended elements based on element type relations between the at least one element type and additional element types associated with a network interface. The element type relations are generated by at least one large language model and at least one optimal relation generation prompt. The computer-implemented method further includes a step of generating an interface including the set of recommended elements.

In various embodiments, a non-transitory computer readable medium having instructions stored thereon is disclosed. The instructions cause a computing device to perform operations including receiving an interface generation request including at least one element type and generating a set of recommended elements based on element type relations between the at least one element type and additional element types associated with a network interface. The element type relations are generated by at least one large language model and at least one optimal relation generation prompt. The instructions further cause the computing device to perform operations including generating an interface including the set of recommended elements.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide a product relation labelling pipeline and interface generation, in accordance with some embodiments;

FIG. 2 illustrates a computer system configured to implement one or more processes, in accordance with some embodiments;

FIG. 3 is a flowchart illustrating a product relation labelling and interface generation method, in accordance with some embodiments;

FIG. 4 illustrates a process flow including various steps of the product relation labelling and interface generation method of FIG. 3, in accordance with some embodiments;

FIG. 5 illustrates a recommendation generation method, in accordance with some embodiments;

FIG. 6 illustrates a relation labelling method, in accordance with some embodiments;

FIG. 7 illustrates a relation labelling module, in accordance with some embodiments;

FIG. 8A illustrates an interface including an interface element container having elements included therein based on known complementary item recommendations;

FIG. 8B illustrates an interface including an interface element container having elements included therein selected based on the disclosed systems and methods including relation labelling; and

FIG. 9 illustrates an artificial neural network, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for product relation labelling using large language models (LLMs). In various embodiments, a labelling pipeline is implemented. The labelling pipeline includes a one or more phases, such as an evaluation phase, a label production phase, and an application phase. An evaluation phase may include generation of benchmark or training data and generation of optimal prompts for use by a trained LLM. In a label production phase, one or more LLMs may be applied to product types in various categories to generate labels. The generated labels may be verified. In an application phase, the generated labels may be applied to interface element recommendations. The interface element recommendations may be re-ranked based on the labels and diversified at a product type level.

In some embodiments, the disclosed systems and methods may be used to provide guardrails for content generation, for example, by automatically tagging irrelevant type assignments based on a requirements within a generated prompt. The generated tags may be used as filters to stabilize recommendations by suppressing entities having irrelevant tags. The disclosed systems and methods may further be configured to provide cross-pollination across network environments and/or entities within the network environment. For example, a label result may be used to generate a relation between a first category of entities and a second category of entities and/or to generate sets of ranked cross-pollinated recall entities.

In some embodiments, the disclosed systems and methods may be configured to provider user relationship management. For example, the disclosed systems and methods may be configured to provide user-relevant interface elements through one or more digital channels based on product type relationships. User-relevant interface elements may include recommended items and/or items related to prior user interactions with a network environment. In some embodiments, recommendations for user-relevant interface elements may include topic-aware product type relationships. For example, the disclosed systems and methods may automatically tag relevant product type pairs based on one or more defined topics and return product type pairs (as discussed herein) for topic-aware recommendations. In some embodiments, the disclosed systems and methods may be integrated with one or more additional pipelines, such as a persona pipeline or an understanding pipeline, to generate correspondence between product types and user preferences for recommendations.

In some embodiments, systems, and methods for product relation labelling using LLMs includes one or more trained LLMs. The trained LLMs may include one or more models, such as a BERT-based LLM, a LLaMA LLM, a Chat-GPT LLM, etc. In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

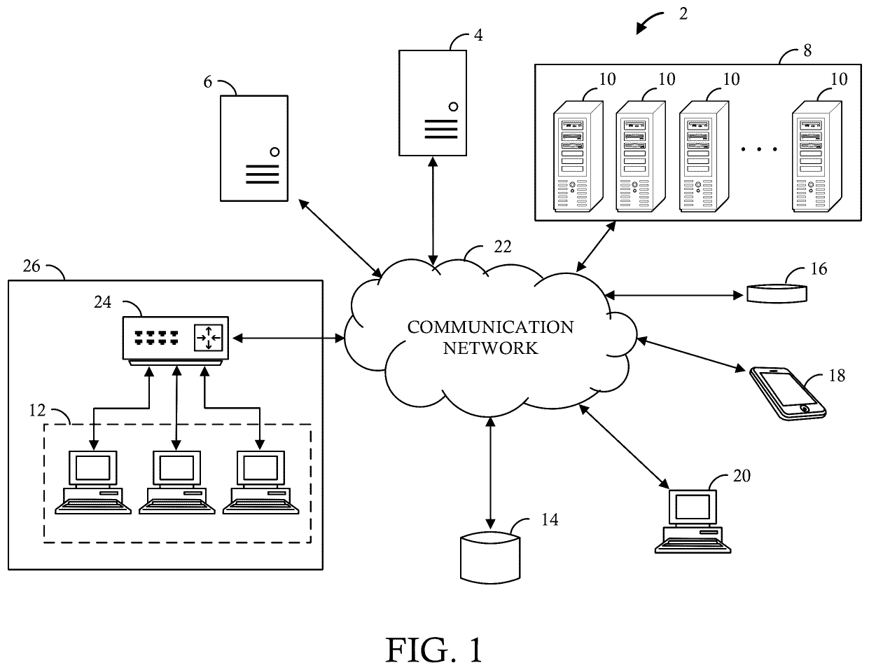

FIG. 1 illustrates a network environment 2 configured to provide a product relation labelling pipeline and interface generation, in accordance with some embodiments. The network environment 2 includes a plurality of devices or systems configured to communicate over one or more network channels, illustrated as a network cloud 22. For example, in various embodiments, the network environment 2 may include, but is not limited to, a product relation labelling computing device 4, a web server 6, a cloud-based engine 8 including one or more processing devices 10, a database 14, and/or one or more user computing devices 16, 18, 20 operatively coupled over the network 22. The product relation labelling computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the product relation labelling computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the product relation labelling computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the product relation labelling computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the product relation labelling computing device 4, for example. The workstation(s) 12 may communicate with the product relation labelling computing device 4 over the communication network 22. The workstation(s) 12 may send data to, and receive data from, the product relation labelling computing device 4. For example, the workstation(s) 12 may transmit data related to tracked operations performed at the physical location 26 to product relation labelling computing device 4.

Although FIG. 1 illustrates three user computing devices 16, 18, 20, the network environment 2 may include any number of user computing devices 16, 18, 20. Similarly, the network environment 2 may include any number of the product relation labelling computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the product relation labelling computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the product relation labelling computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the product relation labelling computing device 4.

In some embodiments, the product relation labelling computing device 4 may execute one or more models, processes, or algorithms, such as an LLM, to generate product relation labels. The product relation labelling computing device 4 may transmit product relation labels to the web server 6 over the communication network 22, and the web server 6 may display interface elements associated with interface elements selected based on the product relation labels on the website to the user. For example, the web server 6 may display interface elements associated with recommended items identified based on product relation labels to the user on a homepage, a catalog webpage, an item webpage, a window or interface of a chatbot, a search results webpage, or a post-transaction webpage of the website (e.g., as the user browses those respective webpages).

In some embodiments, the web server 6 transmits a product relation labelling request to the product relation labelling computing device 4. The product relation labelling request may be generated in response to a specific interface request and/or provided as part of a product labelling pipeline. The product relation labelling computing device 4 implements at least a portion of a product labelling pipeline to generate product relation labels in response to the product relation labelling request. The product relation labels are provided from the product relation labelling computing device 4 to the web server 6 in response to the product relation labelling request.

The product relation labelling computing device 4 is further operable to communicate with the database 14 over the communication network 22. For example, the product relation labelling computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the product relation labelling computing device 4, in some embodiments, the database 14 may be a local storage device, such as a hard drive, a non-volatile memory, or a USB stick. The product relation labelling computing device 4 may store interaction data received from the web server 6 in the database 14. The product relation labelling computing device 4 may also receive from the web server 6 user session data identifying events associated with browsing sessions, and may store the user session data in the database 14.

In some embodiments, the product relation labelling computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The product relation labelling computing device 4 and/or one or more of the processing devices 10 may train one or more models based on corresponding training data. The product relation labelling computing device 4 may store the models in a database, such as in the database 14 (e.g., a cloud storage database).

The models, when executed by the product relation labelling computing device 4, allow the product relation labelling computing device 4 to generate prompts, generate relation labels, verify labels, and/or generate interfaces including labelled elements. For example, the product relation labelling computing device 4 may obtain one or more models from the database 14. The product relation labelling computing device 4 may then receive, in real-time from the web server 6, a labelling request. In response to receiving the labelling request, the product relation labelling computing device 4 may execute one or more models to generate a prompt to be provided to an LLM, generate one or more product labels, and/or verify one or more product labels.

In some embodiments, the product relation labelling computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, product relation labelling computing device 4 may generate label elements for inclusion in element data structures and/or generated interfaces.

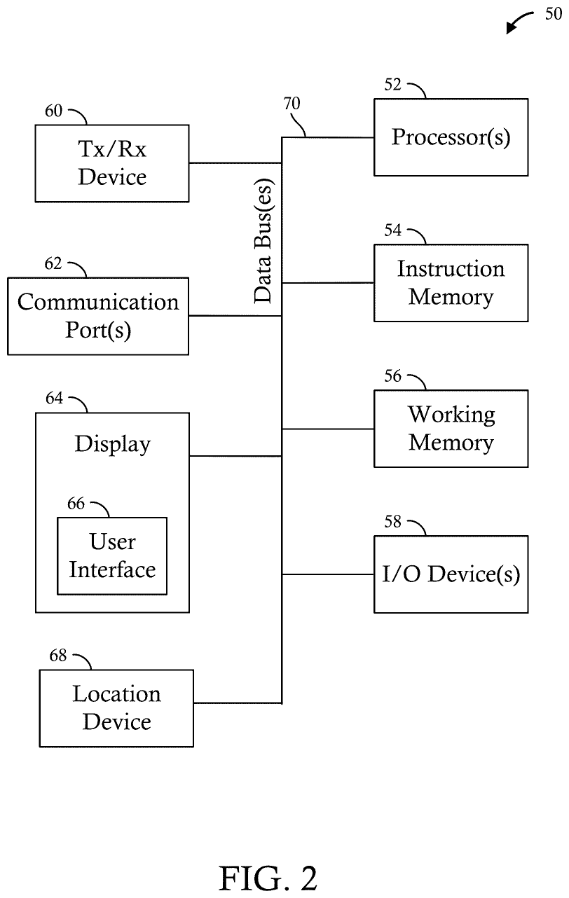

FIG. 2 illustrates a block diagram of a computing device 50, in accordance with some embodiments. In some embodiments, each of the product relation labelling computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for product relation labelling and interface generation, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with interfaces including relationly labelled elements. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

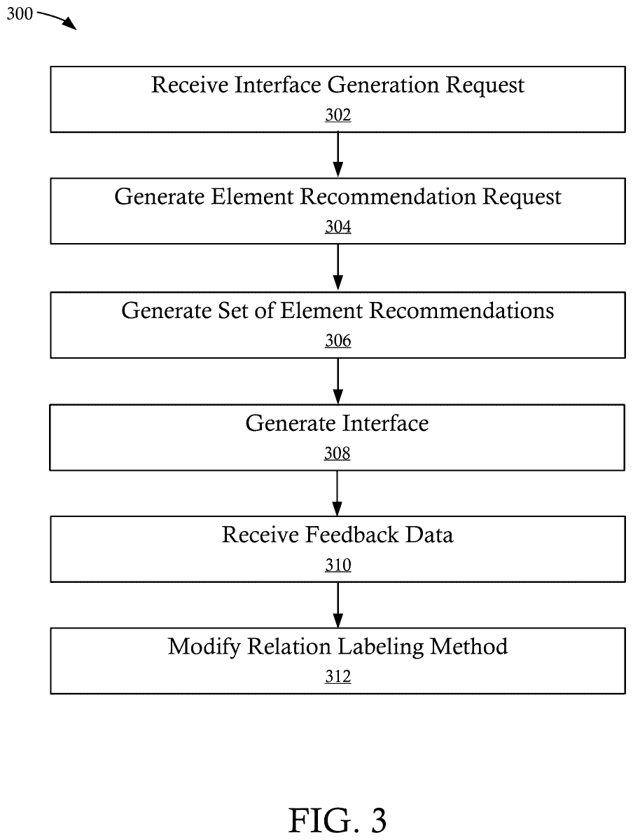

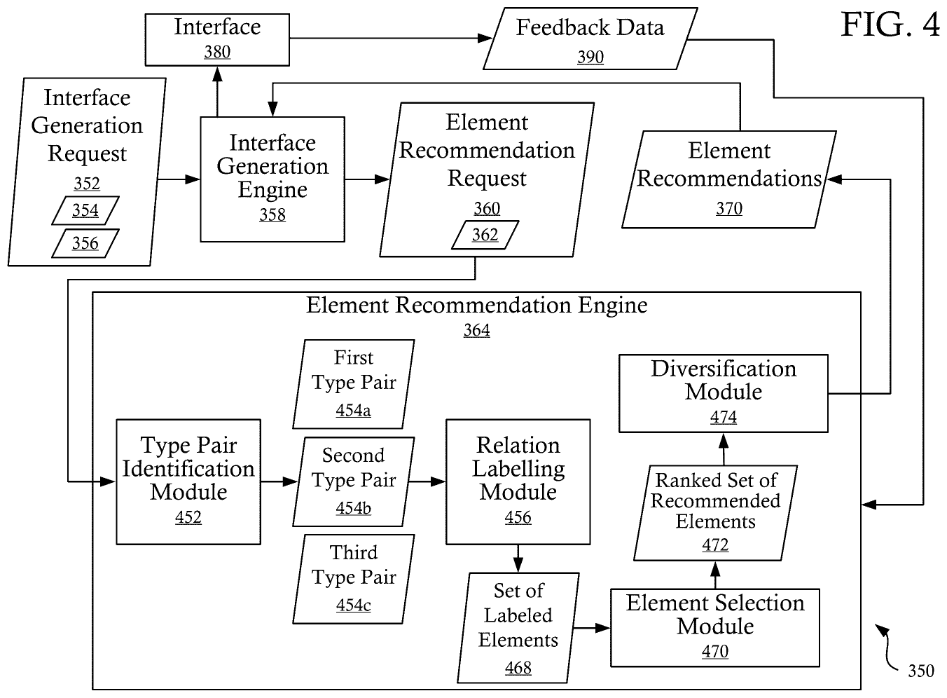

FIG. 3 is a flowchart illustrating a product relation labelling and interface generation method 300, in accordance with some embodiments. FIG. 4 illustrates a process flow 350 including various steps of the product relation labelling and interface generation method 300, in accordance with some embodiments. The product relation labelling and interface generation method 300 may be implemented by any suitable system(s), device(s), module(s), engine(s), etc., such as, for example, the product relation labelling computing device 4, the web server 6, the processing device(s) 10, etc. Although certain steps may be described herein as being performed by certain hardware and/or hardware/software modules, the disclosed steps may be executed by combined and/or additional components.

At step 302, an interface generation request 352 is received. The interface generation request 352 includes a request for a user interface that includes one or more interface elements representative of one or more network elements (“items”) included in a catalog associated with the network environment. The interface elements may include one or more interface elements generated by one or more recommendation processes, such as a similar item recommendation process, a complementary item recommendation process, and/or any other suitable item recommendation process. Recommendation processes may be configured to select interface elements representative of items that are relevant to one or more other items included in the generated interface, other portions the generated interface, the user device and/or associated user associated with the interface generation request 352, etc.

The interface generation request 352 may include a user identifier 354 associated with a user data structure. The user data structure includes one or more data elements including, but not limited to, one or more data elements representative of user features (e.g., self-reported information, user preferences, membership status, etc.), historical interaction data (e.g., data representative of prior interactions with interface elements included in an interface presented via a user device associated with the user identifier), and/or any other suitable user data. The interface generation request 352 may be received by any suitable process, module, engine, etc., such as an interface generation engine 358.

In some embodiments, the interface generation request 352 may include session data 356 including data representative of a current session in which the interface generation request 352 is generated. The session data 356 may include one or more data elements and/or features representative of one or more interactions occurring during a current session, one or more personas or contexts assigned to a current session, one or more session preferences, etc. In some embodiments, session data 356 may identify one or more product types, as discussed in greater detail below.

At step 304, an element recommendation request 360 is generated. The element recommendation request 360 may include a request for one or more recommended (e.g., complementary, similar, etc.) elements to be included within a generated interface. The element recommendation request 360 may include an anchor element identifier 362. The anchor element identifier 362 may be generated based on one or more user interactions identified in the session data 356. For example, in some embodiments, the anchor element identifier 362 corresponds to a most-recent interaction included in the session data 356 identifying an interface element that generated and/or was interacted with in conjunction with the interface generation request 352. In other embodiments, one or more anchor item identifiers 362 may be generated based on historical user interaction data, predetermined by the network environment, and/or otherwise provided for inclusion in the element recommendation request 360.

At step 306, a set of element recommendations 370 is generated in response to the element recommendation request. The set of element recommendations 370 include one or more recommended (e.g., complementary, similar, etc.) elements selected for presentation in a generated user interface. In some embodiments, the set of element recommendations 370 is generated by a recommendation engine 364. The recommendation engine 364 may include one or more modules and/or models, such as, for example, a relation labelling module 456, one or more element selection modules 470, and/or one or more diversification modules 474. In some embodiments, the recommendation engine 364 is configured to implement a recommendation generation method to generate the set of element recommendations 370.

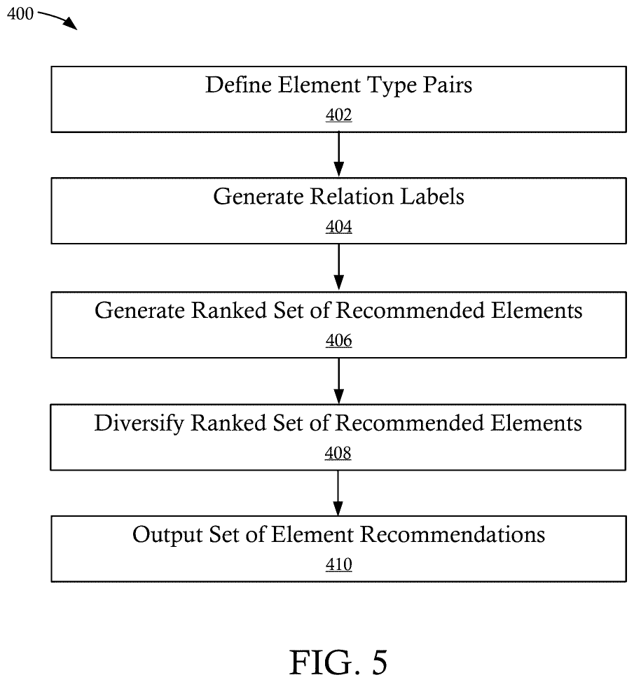

FIG. 5 illustrates a recommendation generation method 400, in accordance with some embodiments. At step 402, a set of element type pairs 454a-454c (collectively “type pairs 454”) are defined. The type pairs 454 may be defined by the element recommendation engine 364, for example, by a type pair identification module 452, and/or may be predefined within the element recommendation request 360. Each of the type pairs 454 includes a first element type item and a second element type (e.g., a target element type).

For example, each element type pair 454a-454c in a set of type pairs 454 may be expressed a doublet <first element type, second element type>. In some embodiments, the first element type and/or the second element type are determined based, at least in part, on the session data 356 included in an interface generation request 352. For example, the session data 356 may include an interaction with an interface element associated with a predetermined element type, such as an anchor element identifier 362. Type pairs 454 may be generated such that each include the predetermined element type as a first element type and a set/subset of the other element types available in the network environment other than the first element type, e.g., a set of type pairs 454 defined as <anchor element type, element type A>; <anchor element type, element type B>, etc., where each of element type A, element type B, etc. are each of the element types utilized by the network environment (or a subset thereof). As another example, a user data structure associated with the user identifier 354 may have one or more predetermined element types associated therewith (such as, for example, preferred element types). Type pairs 454 may be generated that each include at least one of the predetermined element types. Although specific embodiments are discussed herein, it will be appreciated that the first and/or second product types may be selected and/or assigned based on any suitable process.

In some embodiments, the subset of element types utilized for generation of type pairs 454 may be selected based on one or more categorizations of element types, such as, for example, categorizations defining generalized categories of element types. For example, in the context of an e-commerce environment, generalized categories of element types may include general merchandise and grocery categories. Although specific embodiments are discussed herein, it will be appreciated that any suitable generalized categories may be defined for any network environment.

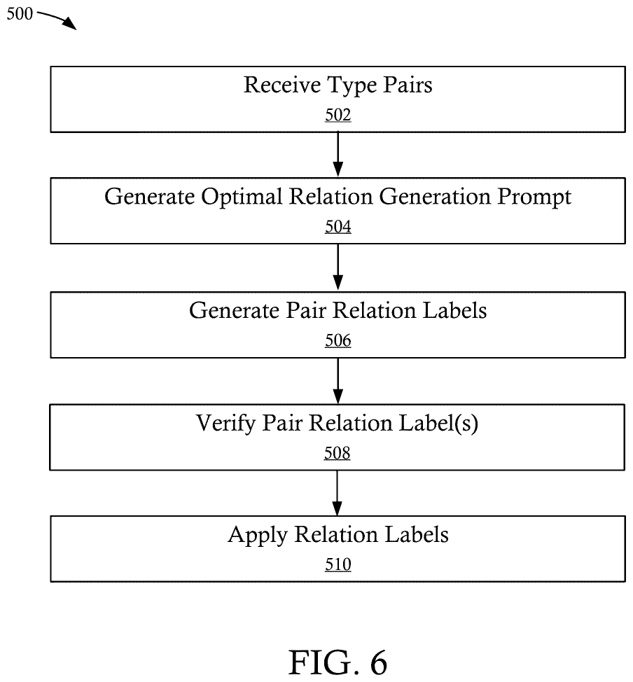

At step 404, a set of relationly labelled elements 468 is generated included elements having corresponding element types for each element type of the type pairs 454. The set of relationly labelled elements 468 may be generated using any suitable process, engine, module, model, etc., such as, for example, a relation labelling module 456 configured to implement a relation labelling method 500, as illustrated in FIG. 6. Although embodiments are discussed herein including implementation of the relation labelling method 500 during execution of the recommendation generation method 400, it will be appreciated that the relation labelling method 500 may be independently executed to pre-generate relation labels for each potential combination of element types within a network environment, e.g., for each potential element type pair including a first element type and a second element type defined within the network environment.

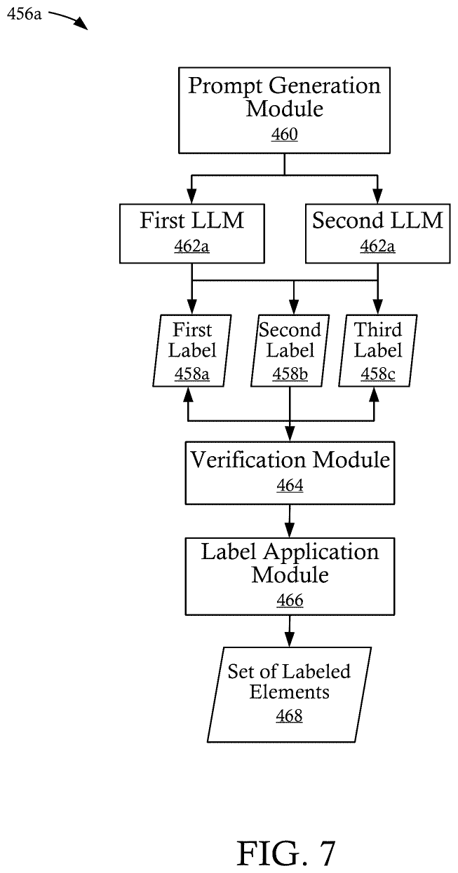

FIG. 6 illustrates a relation labelling method 500, in accordance with some embodiments. FIG. 7 illustrates a relation labelling module 456a, in accordance with some embodiments. At step 502, the type pairs 454 are received and, at step 504, at least one optimal relation generation prompt may be generated for one or more type pairs 454. The optimal relation generation prompt may be generated by any suitable process, system, model, device, etc., such as a prompt generation module 460. In some embodiments, the prompt generation module 460 is configured to generate an optimized prompt based, at least in part, on a template completion process. For example, a pre-generated optimal prompt template may be completed by the prompt generation module 460 to include each of the product type pairs 454. The optimal product relation generation prompt may include, for example, one or more example product type relation label definitions, one or more configurations, each of the product type pairs 454, and output instructions for prompt relation generation results. As another example, in some embodiments, a plurality of optimal product relation generation prompts may be generated with each of the optimal relation generation prompts including one of the product type pairs 454a-454c.

In some embodiments, the optimal relation generation prompt includes a plurality of relation label definitions. The relation label definitions correspond to predetermined classifications of relations between product types. The relation label definitions may be defined for a corresponding downstream use, such as, for example, a set of relation label definitions configured to generate labels suitable for downstream recommendation processes. As one non-limiting example, an optimal product relation generation prompt may include a set of relation label definitions including: complementary, similar, relevant, and irrelevant. In other embodiments, an optimal product relation generation prompt may include label sets such as topic label sets (e.g., room type such as office, bedroom, etc., use relation sets such as outdoor BBQ, winter fun, etc., and/or any other suitable topic label set), competitive vs complementary labels, geographic labels (e.g., country labels, state labels, etc.), and/or any other suitable relation label sets.

In some embodiments, a prompt template may be generated based on training (e.g., benchmark) product relation label data. A prompt engineering training process may be iteratively applied based on the training product relation label data to generate an optimal prompt for outputting the corresponding product relation label from one or more LLMs based on a corresponding input product type pair. In some embodiments, multiple prompt templates may be generated by a prompt engineering training process. Each of the prompt templates may be generated for a corresponding model and/or a corresponding set of features (e.g., a corresponding product type).

A product type pair of <first product type, second product type> may have the same relation label or a different relation label as compared to a product type pair of <second product type, first product type>. For example, where a significant relationship exists in a first direction (e.g., relation of a second product type starting at a first product type) but not in a second direction (e.g., no significant relation of the first product type starting at the second product type), the label output for each of the product type pairs may be different. In some embodiments, the prompt engineering process may be configured to generate an optimal prompt configured to output the same relation label regardless of the order of product types in a corresponding product type pair 454a-454c.

The optimal relation generation prompt may include a baseline prompt, a label definition prompt, and/or a few-shots prompt. A baseline prompt may include a generation prompt having a baseline of information necessary to configure an LLM 462a, 462b for relation labelling. For example, a baseline prompt may include baseline relation definitions (e.g., type relation definitions: substitutable, complementary, or irrelevant), a configuration including at least one interaction and one element type, a set of type pairs 454, and output instructions. A label definition prompt may include a similar and/or identical configuration, set of type pairs 454, and output instructions and a modified relation definition includes express definitions for each relation type (e.g., type relation definitions: substitutable: [definition], complementary: [definition], or irrelevant: [definition]). A few-shot prompt may include a similar and/or identical configuration, set of type pairs 454, and output instructions as a baseline or label definition prompt and a modified relation definition that includes both express definitions and examples for each relation type. The number of examples provided defines the type of few-shot (e.g., 1, 3, 5, etc.) prompt. For example, a few-shot-3 prompt may include relation definitions including three examples (e.g., type relation definitions: substitutable: [definition], such as [first substitutable example pair][second substitutable example pair][third substitutable example pair], complementary: [definition], such as [first complementary example pair][second complementary example pair][third complementary example pair], or irrelevant: [definition], such as [first irrelevant example pair][second irrelevant example pair][third irrelevant example pair]). Although specific embodiments are discussed herein, it will be appreciated that any suitable prompt may be generated and/or utilized by one or more LLMs for generation of relation labels.

In some embodiments, a type of prompt, e.g., few-shot-3, few-shot-5, etc., may be selected based, at least in part, on at least one of the element types included in a type pair 454a-454c. For example, a first prompt type may produce higher accuracy relation labels for elements of a first type and a second prompt type may produce higher accuracy relation labels for elements of a second type. When an element type pair 454a-454c includes an element of a first type, the first prompt type may be selected and when an element type pair 454a-454c includes an element of a second type, the second prompt type may be selected. In some embodiments, an element type of a first element may take precedence over an element type of a second element for assigning a corresponding prompt type (e.g., a prompt type may be selected based on the anchor element type without consideration of the corresponding second element type).

In some embodiments, a prompt type may be selected based, at least in part, on an LLM to be used to generate relation labels. For example, as discussed in greater detail below, when an element type pair 454a-454c includes an element of a first type, a first LLM may be selected for generation of a relation label and when an element type pair 454a-454c includes an element of a second type, a second LLM may be selected. Each LLM may have higher accuracy with a particular prompt type such that the prompt type selected at step 504 is dependent on the LLM 462a, 462b that will be applied in subsequent steps. For example, each element type may have a specific LLM associated therewith and the specific LLM may have a specific prompt type associated therewith. As another example, each element type may have an element-specific LLM and an element-specific prompt for the corresponding element-specific LLM. Although specific embodiments are discussed herein, it will be appreciated that any suitable criteria may be used to select a corresponding prompt type for an optimal relation generation prompt.

At step 506, pair relation labels 458a-458c (collectively “relation labels 458”) are generated for each of the type pairs 454. In some embodiments, pair relation labels 458 are generated by one or more generative models, such as one or more LLMs 462a, 462b (collectively “LLMs 462”). The optimal relation generation prompt may be provided to the one or more LLMs 462. For example, in some embodiments, a single optimal product relation generation prompt may be provided to one or more LLMs 462, which are configured to generate product relation labels based, at least in part, on the optimal product relation generation prompt. As another example, in some embodiments, LLM-specific optimal product relation generation prompts are generated and each is provided to a corresponding one of a plurality of LLMs 462. The one or more LLMs 462 may include any suitable LLM, such as, for example, GPT-3.5, GPT-4.0, PaLM, PaLM 2, LLAMA, LLAMA 2, etc.

The one or more LLMs 462 generate pair relation labels 458 for each type pair 454 identified in a product relation generation prompt provided to the corresponding one of the LLMs 462. The pair relation labels 458 include one of a plurality of labels defined in the optimal product relation generation prompt, as discussed above. For example, in some embodiments, the pair relation labels 458 include one of a predefined set of labels including complementary, similar, relevant, and irrelevant labels. Although embodiments are discussed herein including generation of a single product pair relation label 458 for each corresponding type pair 454a-454c, it will be appreciated that two or more pair relation labels 458 may be generated for each of the type pairs 454. For example, a first LLM 462a may be configured to generate a first relation label for each of the type pairs 454 selected from a first set of predefined relation labels (e.g., complementary, similar, relevant, and irrelevant) and a second LLM 462b may be configured to generate a second relation label for each of the type pairs 454 (e.g., topic labels).

In some embodiments, one or more LLMs 462 are configured to generate a type relation score for each of the type pairs 454 indicative of a probability or strength of one or more relations between the element types. For example, in embodiments including a set of relation labels including complementary, similar, relevant, and irrelevant, each of the LLMs 462 may be configured to output a type complementary score indicative of the likelihood and/or strength of a second element type being complementary to a first element type (e.g., an anchor element type). Type relation scores may be generated for each assigned relation type (e.g., a relation labelled as a complementary relation may include a complementary score, a relation labelled as a similar relation may include a similar score, etc.), may be generated only for selected relation labels (e.g., a complementary score is generated only for relations labelled as complementary relations), may be generated for all relations regardless of label (e.g., a complementary score may be generated for all relations whether labelled as a complementary relation or other label), etc. A type relation score may be used in ranking of element types for inclusion in a set of recommended elements 370, as discussed below.

In some embodiments, an LLM 462a, 462b applied to generate a relation label is selected based on at least one of the element types included in a type pair 454a-454c. For example, a first LLM 462a may have higher accuracy identifying relation labels for elements of a first type and a second LLM 462b may have higher accuracy identifying relation labels for elements of a second type. When an element type pair 454a-454c includes an element of a first type, the first LLM 462a may be selected for generation of a relation label 458a-458c and when an element type pair 454a-454c includes an element of a second type, the second LLM 462b may be selected. In some embodiments, an element type of a first element may take precedence over an element type of a second element for assigning a corresponding LLM (e.g., LLMs may be selected based on the anchor element type without consideration of the corresponding second element type).

At step 508, one or more of the generated relation labels 458 may be verified. Verification may include review and/or comparison of one or more generated labels to predetermined and/or previously generated labels. For example, in some embodiments, the type pairs 452 may include one or more type pairs for which a relation label 460 has been previously generated. A generated relation label 458a-458c may be compared to one or more previously generated relation labels to ensure consistency and/or to identify an expected change. Expected changes may include identification of previously undetected relationships (e.g., a change in a relation label from “irrelevant” to “relevant” may reflect a later understanding of a previously undetected or unappreciated relationship within a type pair), identification of changing trends or relationships (e.g., a change in relation label from “relevant” to “complementary” may reflect a change in user interaction behavior with respect to a type pair), correction of incorrectly identified relationships (e.g., a change in a relation label from “complementary” to “similar” may reflect a correction of a relationship from a previously identified co-use relationship to a replacement-type relationship), etc.

In some embodiments, verification may be performed, at least in part, via a verification module 464 configured to generate a verification output. The verification module 464 receives each of the generated relation labels 458 and outputs a set of verified relation labels 469. In some embodiments, a threshold number of checked relation labels (e.g., 100%, 95%, 90%, 80%, etc.) are required for approval of the generated relation labels 458. As another example, the verification may include a percentage for one or more of the relation labels 458 indicative of a probability of the relation label being correct. In such embodiments, a probability for a corresponding relation label 458 may be verified when above a predetermined threshold. In some embodiments, the verification module 464 is configured to utilize, at least in a part, a human-in-the-loop (HitL) process.

At step 510, the relation labels 458, e.g., set of verified relation labels 469, are applied to (e.g., stored in conjunction with and/or with a reference to) one or more elements having a corresponding element types of at least one type pairs 454 to generate a set of labelled elements 468 (e.g., catalog elements including the a relation label indicating a relation between an element type of the catalog element and one or more other element types). The relation labels 458 may be applied by any suitable module, engine, etc., such as, for example, a label application module 466. The label application module 466 may be configured to modify a data structure, such as an element type data structure, to include the relation label and corresponding other element type (e.g., modifying a first element type data structure to include identification of a second element type and a corresponding relation label 458). As another example, in some embodiments, the relation labels 458 may be maintained by a database system and/or within a master list accessible to one or more network systems.

In some embodiments, step 510 may be omitted and the relation labels 458 may be provided as an output from the relation labelling method 500. The relation labels 458 may be provided to and/or applied directly by one or more recommendation processes to generate a set of recommended elements, as discussed in greater detail below. Additionally and/or alternatively, the label application module 466 may be operated independently of the relation labelling module 456a and may be configured to separately generate the set of labelled elements 468 based on the relation labels 458 received from the relation labelling module 456a.

With reference again to FIG. 5, at step 406, a ranked set of recommended elements 472 is generated based, at least in part, on the relation labels 458. For example, in some embodiments, one or more element selection processes may be implemented by an element selection module 470 to generate the ranked set of element recommendations 472. The one or more element selection processes may include any suitable element selection process, such as, for example, a complementary item recommendation process, a similar item recommendation process, and/or any other suitable recommendation and/or element selection process. In some embodiments, each of the element selection processes are configured to generate ranked sets of recommended elements based, at least in part, on the relation labels 458 included in the set of labelled elements 468, allowing the one or more element selection processes to define additional and/or alternative recall sets of elements as compared to operation of such processes without the relation labels 458.

For example, one or more element selection processes may be limited to only element types that are identified with a selected relation label, such as limiting a complementary recommendation process to only element types identified as complementary or limiting a similar recommendation process to only element types identified as similar. For example, a complementary item recommendation process may be configured to rank or re-rank recall item sets to improve complementary qualities of the top complementary elements selected by the complementary item recommendation process. As another example, a similar item recommendation process may be configured to utilize a relation label to identify additional similar elements for inclusion in a similar element recall set. Although specific embodiments are discussed herein, it will be appreciated that the labelled elements 468 may be provided to any suitable selection processes for enhancement and/or modification of the corresponding selection process.

In some embodiments, the ranked set of element recommendations 472 may be generated by applying one or more reranking processes and/or techniques to an output of the one or more element selection processes without modifying the underlying one or more element selection processes to utilize the relation labels 458. For example, an initial set of recommended elements may be generated by the one or more element selection processes and the initial set of recommended elements may be re-ranked, at least in part, based on applied relation labels 458 by one or more ranking sub-modules implemented by the element selection module 470. In some embodiments, at least one of the one or more element selection processes may be modified to incorporate use of the relation labels 458 and a subsequent re-ranking module may be applied to the output of one or more element selection processes to re-rank at least one initial set of element recommendations to generate the ranked set of element recommendations 472.

In some embodiments, the ranked set of element recommendations 472 are generated, at least in part, based on one or more type relation scores for each of the type pairs 454. For example, a ranked set of element recommendations 472 may include only those element types labelled as complementary. Elements having an element type with a higher complementary relation score may be ranked higher as compared to elements having an element type with a lower complementary relation score. A type relation score may be used in conjunction with additional values, such as element-specific features or values, to determine a final ranking of individual elements within the set of element recommendations 472.

In some embodiments, the ranked set of element recommendations 472 are generated by bucketing and re-ranking outputs of at least one of the one or more element selection processes. For example, a complementary element selection process may be configured to generate a set of complementary items using one or more known complementary item generation processes. The set of complementary items may be sorted into one or more buckets (e.g., categories) based on type labels assigned to each of the element types for the generate set of complementary items (e.g., the complementary items may be sorted into buckets corresponding to assigned relation labels such as complementary, relevant, irrelevant, etc.). After sorting, the complementary items within each bucket may be ranked based on the corresponding complementary score (or other relation type score) for each corresponding element type. In some embodiments, one or more buckets, such as an irrelevant bucket, may include elements that are ignored and/or eliminated from consideration. The ranked set of elements within each of the buckets (e.g., remaining buckets) are appended to generate a final ranked set of element recommendations 472, for example, by appending the individual bucket sets in a predetermined order such as complementary—relevant—irrelevant.

At step 408, the ranked set of element recommendations 472 are diversified based on the relation labels to generate the set of element recommendations 370. Diversification may be applied by any suitable process, engine, system, module, etc., such as, for example, a diversification module 474. The diversification module 474 may be configured to diversify the ranked set of element recommendations 472 by inserting and/or modifying rankings of individual recommended elements based on one or more element type-level instructions. For example, in some embodiments, the diversification module 474 may be configured to insert one or more predetermined elements from one or more of the element types included in the ranked set of element recommendations 472. The predetermined elements may include, for example, elements in the corresponding element types having a highest number of interactions over a predetermined period. As another example, in some embodiments, the diversification module 474 may be configured to insert user-preferred elements from one or more of the element types included in the ranked set of element recommendations 472 when those elements are not otherwise included. Although specific embodiments are discussed herein, it will be appreciated that the diversification module 474 may be configured to apply any suitable diversification criteria. Additionally, although embodiments are illustrated herein with a separate diversification module 474, it will be appreciated that one or more diversification processes may be implemented by the element selection processes, either alternatively and/or in addition to diversification processes applied by a separate diversification module 474.

In some embodiments, a round-robin diversification process is applied to select elements from non-consecutive element types while maintaining a relative order of ranked elements within each bucket. For example, a round-robin diversification process may be configured to select elements from a first bucket, such as a complementary bucket. A highest ranked element in the complementary bucket may be selected. A second highest ranked element in the complementary bucket may be subsequential selected if the second highest ranked element is associated with a different element type as compared to the highest ranked element. If second highest ranked element has the same element type as the first highest ranked element, the round-robin diversification process will select the next-highest ranked element having a different element type. The round-robin diversification process may iteratively select elements from the first bucket, e.g., the complementary bucket, until the selection criteria can no longer be satisfied, at which point a second bucket and/or a third bucket may be utilized and/or the round-robin selection criteria may be relaxed and/or waived.

At step 410, the set of element recommendations 370 are output. Although the recommendation generation method 400 is illustrated as part of an interface generation method 300, it will be appreciated that the recommendation generation method 400 may be executed as an offline and/or batch process to pre-generate sets of recommended elements for one or more users. For example, user interactions may be logged and stored in an interaction datastore, such as database 14. The user interactions may include interactions with elements having one or more element types. During a predetermined period, a recommendation generation method 400 may be executed to generate sets of element recommendations 370 for each element type identified in and/or associated with the user interactions. The generated sets of element recommendations 370 may be stored and/or saved for use by an interface generation method 300 during a subsequent user session.

Similarly, although the relation labelling method 500 is illustrated as part of the recommendation generation method 400, it will be appreciated that the relation labelling method 500 may be executed as an independent process and/or as an offline/batch process. For example, user interactions may be logged and stored in an interaction datastore, such as database 14. The user interactions may include interactions with elements having one or more element types. During a predetermined period, a relation labelling method 500 may be executed to generate user-specific relation labels for each element type identified in and/or associated with the user interactions. The user-specific relation labels may be stored and/or saved for use by an a recommendation generation method 400 during a subsequent user session and/or subsequent offline process.

With reference again to FIG. 3, at step 308, an interface 380 is generated including one or more of the elements identified in the set of element recommendations 370. The subset of the element recommendations 370 selected for inclusion in the interface 380 may include all of the elements in the set of element recommendations 370 and/or a portion of the elements in the set of element recommendations 370. The selected elements may be selected in ranked order (e.g., highest ranked elements first), randomly selected, selected based on any suitable criteria, etc. As one non-limiting example, in some embodiments, the set of element recommendations 370 may be presented in one or more element containers, such as one or more carousels 382, included in the generated interface 380.

The interface may be generated by generating and transmitting instructions for a user device to generate the interface 380 locally. The transmitted instructions may include instructions for obtaining interface elements, including the element recommendations 370, from one or more network-accessible locations and/or may include interface elements, such as the selected elements, embedded within the instructions. Although specific embodiments are discussed herein, it will be appreciated that the interface 380 may be generated using any suitable interface generation process, such as template completion, modification of cached interfaces, etc.

At optional step 310, feedback data 390 is received. Feedback data may include one or more interactions with one or more of the element recommendations 370, e.g., one or more interface elements representative of an element in the set of element recommendations 370. The feedback data 390 may be indicative of relationships (or lack thereof) between element types, such as an anchor element type and one or more second element types included in the set of element recommendations 370.

At optional step 312, one or more elements of the relation labelling method 500 may be adjusted based on the feedback data 390. For example, when the feedback data 390 indicates a specific relationship between two or more element types that is not reflected in the output of the relation labelling method 500, the optimal relation generation prompt may be modified to expressly identify the specific relationship as an example of relationships to be identified by the LLM(s). As another example, when the feedback data 390 indicates an identified relation is incorrect, the optimal relation generation prompt may be modified to expressly exclude the identified relation. Although specific embodiments are discussed herein, it will be appreciated that any suitable portions of the disclosed systems and methods may be modified based on the feedback data 390.

The disclosed relation labelling and interface generation method 300 provides an improvement over interfaces generated using traditional element recommendation processes, for example, by providing higher relevance recommended elements for inclusion in generated interfaces. The disclosed relation labelling and interface generation method 300 improves user interface interactions by increasing coverage of network elements, providing higher quality of recalled elements, improving default modes of element recommendation, and/or improving known recommendation models (e.g., complimentary item (CI) recommendation).

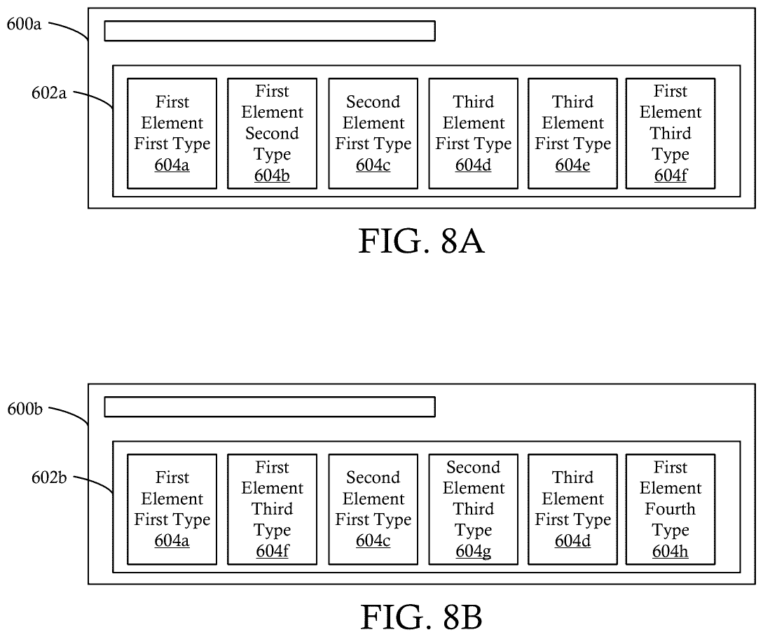

FIG. 8A illustrates an interface 600a including an interface element container 602a having elements included therein based on known complementary item recommendations. FIG. 8B illustrates an interface 600b including an interface element container 602b having elements included therein selected based on the disclosed systems and methods including relation labelling. As illustrated in FIGS. 8A and 8B, the use of the disclosed systems and methods result in an interface 600b including diversified, complementary items. The element containers 602a, 602b include the same element in a first position, e.g., element 604a. The element container 602b includes diversified, complementary items such that an element 604e originally positioned in the sixth position of the element container 602a is now positioned at the second position in element container 602b. Additionally, the element container 602b includes diversified elements as compared to the element container 602a, such that the third, fourth, and fifth, positions include diversified element types, as compared to the element container 602a which has the same element type at the third, fourth, and fifth positions.

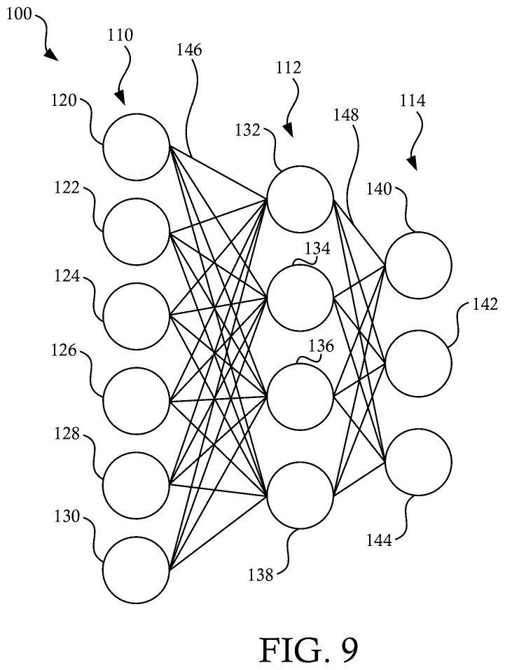

FIG. 9 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 9 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

Identification of recommended interface elements associated with related element types can be burdensome and time consuming for users, especially if recommendations are provided without consideration of element type relations. Typically, a user may locate information regarding interface elements by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding relevant interface elements.

Systems including relationly labelled elements, as disclosed herein, significantly reduce this problem, allowing users to locate relevant interface elements with fewer, or in some case no, active steps. For example, in some embodiments described herein, when a user is presented with elements having similar type, each interface element includes, or is in the form of, a link to an interface page for interaction with the relevant interface element. Each recommendation thus serves as a programmatically selected navigational shortcut to an interface page, allowing a user to bypass the navigational structure of the browse tree. Beneficially, programmatically identifying relevant interface elements having relation element types and presenting a user with navigations shortcuts to these tasks may improve the speed of the user's navigation through an electronic interface, rather than requiring the user to page through multiple other pages in order to locate the relevant interface elements having relation element types via the browse tree or via a search function. This may be particularly beneficial for computing devices with small screens, where fewer interface elements are displayed to a user at a time and thus navigation of larger volumes of data is more difficult.

It will be appreciated that automated relation labelling as disclosed herein, particularly on large datasets intended to be used interface generation systems in the context of e-commerce, is only possible with the aid of computer-assisted machine-learning algorithms and techniques, such as the disclosed relation labelling processes. In some embodiments, machine learning processes including LLMs are used to perform operations that cannot practically be performed by a human, either mentally or with assistance, such as relation labelling of interface elements for large scale network interfaces. It will be appreciated that a variety of machine learning techniques can be used alone or in combination to generate relevant interface elements having relation element types.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a processor; and
a non-transitory memory storing instructions that, when executed, cause the processor to:
receive an interface generation request including at least one element type;
generate a set of recommended elements based on element type relations between the at least one element type and one or more additional element types associated with a network interface, wherein the element type relations are generated by at least one large language model and at least one optimal relation generation prompt; and
generate an interface including the set of recommended elements.

2. The system of claim 1, wherein the set of recommended elements are generated by one of a similar item recommendation process or a complementary item recommendation process.

3. The system of claim 1, wherein the element type relations are generated based on an anchor item.

4. The system of claim 1, wherein the element type relations comprise doublets including a first type and a second type.

5. The system of claim 1, wherein the at least one large language model receives a prompt generated by a template completion process.

6. The system of claim 5, wherein the prompt comprises relational label definitions.

7. The system of claim 6, wherein the relational label definition are unidirectional.

8. A computer-implemented method, comprising:
receiving an interface generation request including at least one element type;
generating a set of recommended elements based on element type relations between the at least one element type and additional element types associated with a network interface, wherein the element type relations are generated by at least one large language model and at least one optimal relation generation prompt; and
generating an interface including the set of recommended elements.

9. The computer-implemented method of claim 8, wherein the set of recommended elements are generated by one of a similar item recommendation process or a complementary item recommendation process.

10. The computer-implemented method of claim 8, wherein the element type relations are generated based on an anchor item.

11. The computer-implemented method of claim 8, wherein the element type relations comprise doublets including a first type and a second type.

12. The computer-implemented method of claim 8, wherein the at least one large language model receives a prompt generated by a template completion process.

13. The computer-implemented method of claim 12, wherein the prompt comprises relational label definitions.

14. The computer-implemented method of claim 13, wherein the relational label definition are unidirectional.

15. A non-transitory computer readable medium having instructions stored thereon, wherein the instructions, when executed by at least one processor, cause at least one device to perform operations comprising:
receiving an interface generation request including at least one element type;
generating a set of recommended elements based on element type relations between the at least one element type and additional element types associated with a network interface, wherein the element type relations are generated by at least one large language model and at least one optimal relation generation prompt; and
generating an interface including the set of recommended elements.

16. The non-transitory computer readable medium of claim 15, wherein the set of recommended elements are generated by one of a similar item recommendation process or a complementary item recommendation process.

17. The non-transitory computer readable medium of claim 15, wherein the element type relations are generated based on an anchor item.

18. The non-transitory computer readable medium of claim 15, wherein the element type relations comprise doublets including a first type and a second type.

19. The non-transitory computer readable medium of claim 15, wherein the at least one large language model receives a prompt generated by a template completion process.

20. The non-transitory computer readable medium of claim 15, wherein the prompt comprises unidirectional relational label definitions.
